(19) United States
(12) Patent Application Publication
(10) Pub. No.: US 2014/0245653 A1
(43) Pub. Date: Sep. 4, 2014

(54) GOOSE FLAG DECOY SYSTEM

(71) Applicant: Jeff Foster, Chesapeake City, MD (US)

(72) Inventor: Jeff Foster, Chesapeake City, MD (US)

(21) Appl. No.: 13/783,799

(22) Filed: Mar. 4, 2013

(51) Int. Cl. A01M 31/06; A01M 99/00

(52) U.S. Cl. CPC A01M 31/06; A01M 99/00
USPC 43/3

(57) ABSTRACT

A goose flag decoy system simulates flapping wing motion of a goose or other waterfowl, particularly the motion when such goose is landing. A flag pole is pivotably mounted at one end to a base plate that is secured to a ground surface and has a goose flag mounted at or near its opposite end. The flag pole is biased and held in down or grounded position by a stretchable elastic cord tethered at one end to a ground surface and at the other end to the flag pole. A pull cord or string is tethered the flag pole and is directed through one or more eyelets or pulleys. Tugging motion on the pull cord overcomes tension of the stretchable elastic cord and raises the flag pole from its grounded position. Back and forth tugging motion on the pull cord causes the goose flag to move, simulating flapping wing motion.

### BACKGROUND

1. Field of the Invention

The present invention relates to animated water fowl decoys (e.g., duck or goose) that similate wing flapping movement, particularly wing flapping movements that are made when such water fowl land from flight.

2. Background

Hunters frequently use decoys to attract game birds. Animated decoys can include mechanisms to replicate movements of feeding birds or landing birds in an attempt to lure other birds to a hunting location. See, e.g., U.S. Pat. No. 5,231,780.

Duck and goose windsocks and flags have been proposed that can be attached to strings and flown like kites. Other duck and goose flags can be appended to sticks or poles for a hunter to shake manually to impart flutter movements.

Some decoy systems incorporate a staked decoy body to which movable parts are joined, such as a tail fan or wings. The movable parts may be moved by action of a pull cord attached thereto. See, e.g., U.S. 2012/0042561 A1; U.S. Pat. No. 8,230,638; U.S. Pat. No. 7,225,579; and U.S. Pat. No. 6,487,810. Many such decoy systems lack realism in their movements, making them less effective at luring game birds, such as water fowl, to the hunter's location.

Improvements to animated decoy systems continue to be sought.

### SUMMARY

A decoy system includes a mounting securable to a ground surface to which a pole is pivotably attached. A decoy flag is attached or joined at or near the top end of the pole. A resilient cord is attached or joined at or near one end to the pole and securable at or near its other end to a ground surface. The resilient cord may be an elastic band or a bungee cord that biases the decoy flag and flag pole to a down or grounded position. An upright associated with the mounting defines a pull cord pathway. A pull cord is secured at one end to the pole and traverses the pull cord pathway. The pull cord pathway may be a pulley. A hunter may tug on the pull cord to overcome the biasing force of the resilient cord and raise the flag pole and decoy flag up from the grounded position. Once the flag pole and decoy flag are raised, the hunter may tug on and release the pull cord to induce flapping or fluttering motion in the goose flag.

In one embodiment, the decoy system further includes a pull cord redirection mechanism. The pull cord redirection mechanism has a pulley wheel mounted to a stake, with said stake securable to or into a ground surface. Where the redirection mechanism is used, the pull cord may be a longer length to permit the hunter to operate the decoy system at a greater distance from the decoy system.

### BRIEF DESCRIPTION OF THE DRAWINGS

The drawings described herein are for illustrative purposes only and are not intended to limit the scope of the present disclosure. In the drawings, wherein like reference numerals refer to similar components:

FIG. 1 is a perspective view of a decoy system according to the invention;

FIG. 2A is a right side elevation view of a redirection mechanism with a roller and a stake;

FIG. 2B is a left side elevation view of the redirection mechanism with a pull cord associated therewith;

FIG. 2C is a top plan view of the redirection mechanism with a pull cord associated therewith;

FIG. 2D is an enlarged cross-sectional view of the redirection mechanism;

FIG. 2E is a left side elevation view of the redirection mechanism;

FIG. 3 is a left perspective view of the decoy system showing a mounting or bracket assembly with upright connected therewith and with flag pole and associated decoy flag;

FIG. 4A is a left side elevation view of the bracket assembly with upright connected therewith and with flag pole connected therewith;

FIG. 4B is a left side elevation view of the upright;

FIG. 4C is a rear elevation view of the upright;

FIG. 4D is a top plan view of a bracket piece forming one half of a bracket assembly;

FIG. 4E is a top plan view of a bracket spacer;

FIG. 5 is a left side elevation view of a flag pole; and

FIG. 6 is a bottom plan view of a goose flag.

### DETAILED DESCRIPTION

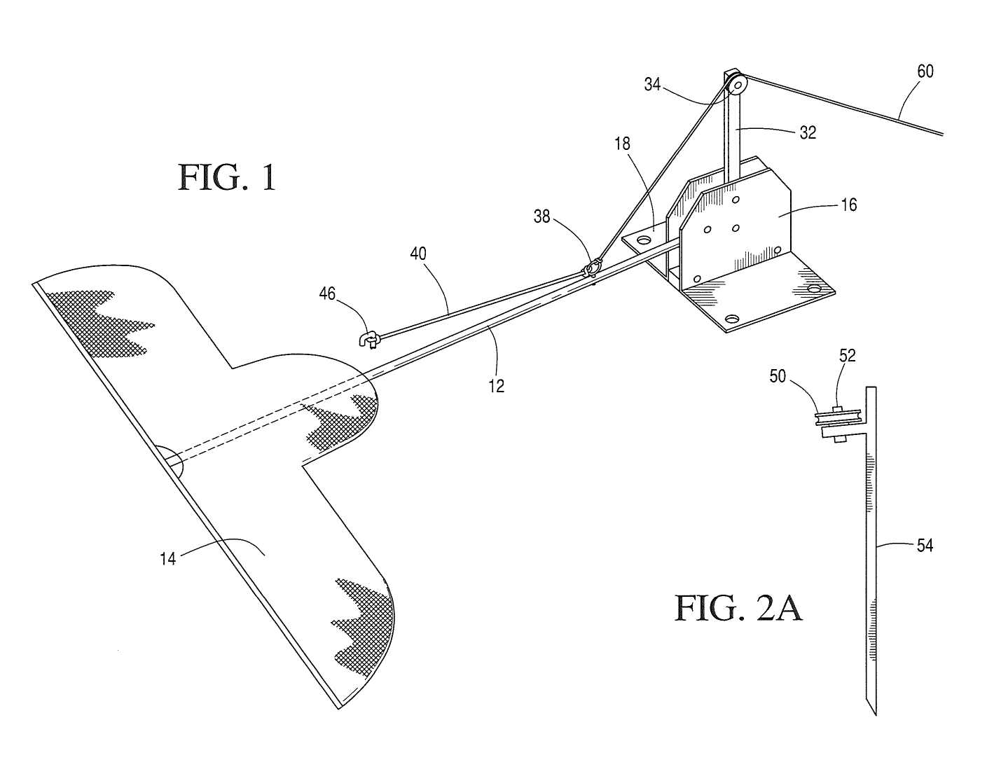

Referring first to FIG. 1, a decoy system 10 includes a flag pole 12 having a top end and a bottom end. A decoy flag 14, such as a goose flag, is appended or joined to the top end of the flag pole 12 and optionally is secured also to a mid-point of the flag pole. The flag pole 12 is secured for pivoting or rotational movement at its bottom end to a mounting comprising one or more brackets 16, 18. The mounting is secured to a mounting surface, such as the ground, with one or more stakes 20. An upright 24 having a top end and a bottom end extends upwardly from the mounting 16, 18. The bottom end of the upright 24 is connected to the mounting, and the top end of the upright 24 defines an opening through which a pulley 34 is mounted on a shaft 32. An eyelet 38 extends from a side surface of the flag pole 12. A resilient cord 40 is linked to the eyelet 38. A tether or pull cord 60 is linked to the eyelet 38 and traverses over the pulley 34.

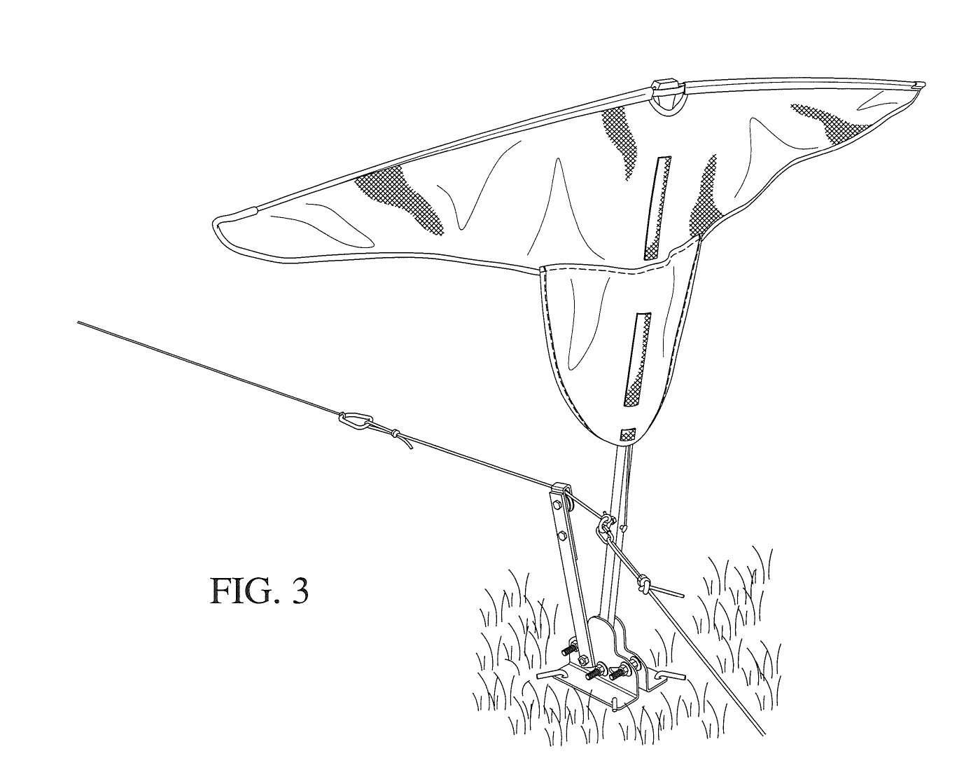

Turning now to each component in more detail, the flag pole 12 (see FIG. 5) may comprise any material with sufficient rigidity to withstand flexing motions and weather conditions for outdoor use. One suitable material is an aluminum tube with a ½-inch outer diameter and an length of about 30 to 40 inches, preferably about 36 inches. The aluminum tube may have a circular, square or other cross-sectional configuration. As shown in FIGS. 3 and 5, the flag pole 12 comprises an aluminum tube with a square cross-section.

To facilitate joining the flag pole 12 to the mounting 16, 18 for pivoting or rotational movement, a hole 64 is formed at or near the bottom end of the flag pole 12. To facilitate appending or joining a flag 14 to the flag pole 12, a hole 66 is formed at or near the top end of the flag pole 12. To facilitate joining the eyelet 38 to the flag pole 12, a hole 68 is formed along the length of the flag pole 12. Referring to FIG. 5, the hole 68 is formed at a location between the upper end and the lower end, and preferably at a location that is along the lower half of the flag pole 12.

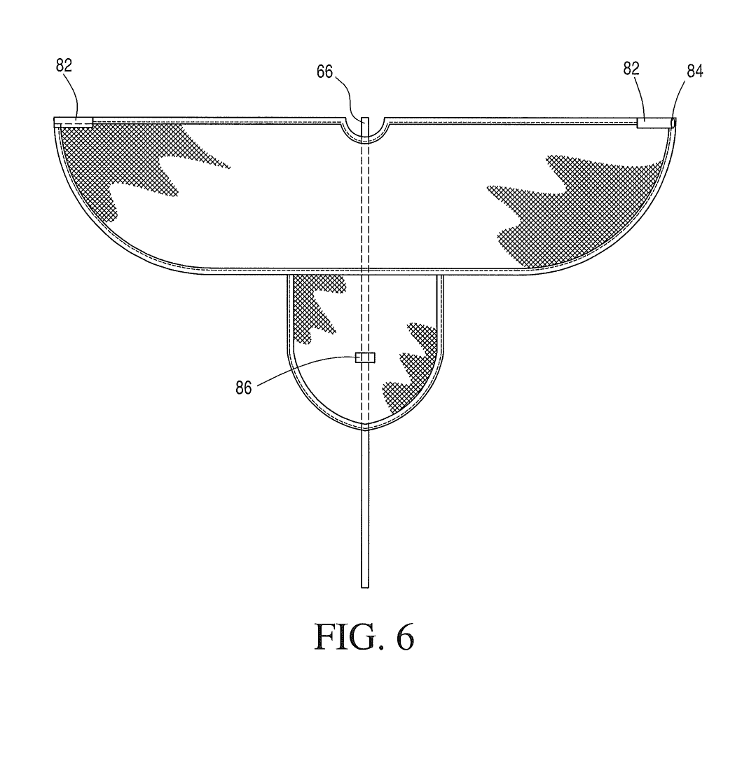

The decoy flag 14 may be a goose flag of canvas, polyester, rip-stop nylon, denim or other textile that is joined to a dowel rod, fiberglass rod, or other stay 78 extending across a top portion of the flag. See FIG. 6. The flag material should be of a kind suitable to withstand weather conditions for outdoor use, and of a color suitable as an attractant for waterfowl, such as but not limited to, black or brown or mixed color comparable to duck or goose feathers. The flag 14 generally has a configuration of an outline of a goose body with extended wings. The dowel or rod extending across the top portion stiffens the extended wing portions of the flag. A dowel or stay or other stiffening member may be provided at the goose body portion of the flag. The flag 14 shown in FIGS. 1 and 3 is representative of the type of flag that may be used in the decoy system 10 of the invention, but is not intended to be limiting. Other flags for other water fowl or game birds also may be used in the decoy system 10.

The top portion of the flag 14 is joined or fastened to a top portion of the flag pole 12. As shown in FIG. 6, the dowel or rod extending across the top portion of the flag is inserted through a receiving hole 66 in the flag pole 12. In this embodiment, the dowel or rod 78 has a length of 49.5 inches and a diameter of ⅛ inch. It is held within double-reinforced piping 82 at the leading edges of the wing portions of the goose flag 12. At one corner, a snap fastener 84 encloses the piping 82. Loops of hook and loop fasteners 86 (e.g. Velcro) may be attached to the bottom surface of the goose flag 12 so that the goose flag 12 may be secured to other mounting surfaces.

Optionally, a pin may extend from a side surface of the flag pole 12 to facilitate securing a bottom portion of the goose flag 14 to the flag pole 12. Some goose flags are provided with roping or string extending from a bottom or body portion thereof.

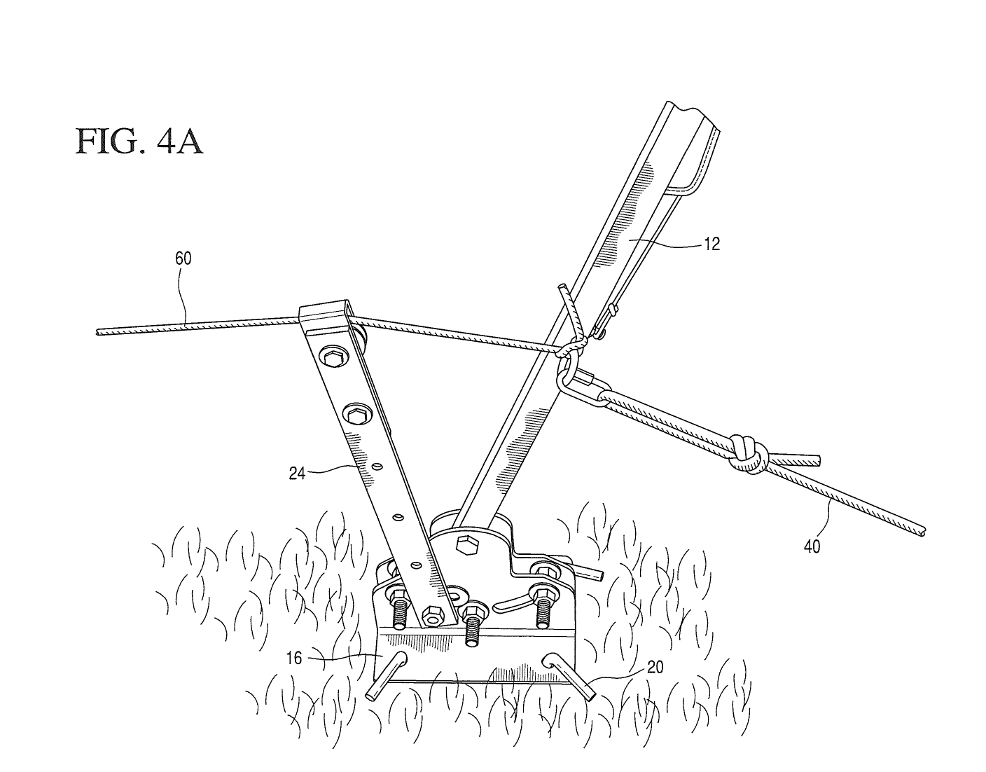

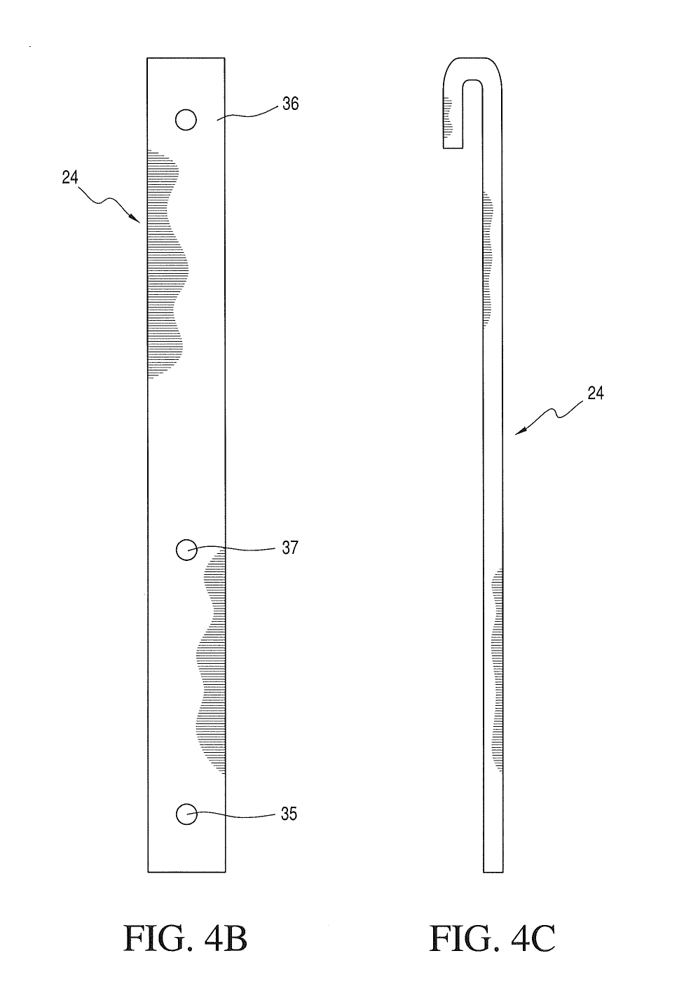

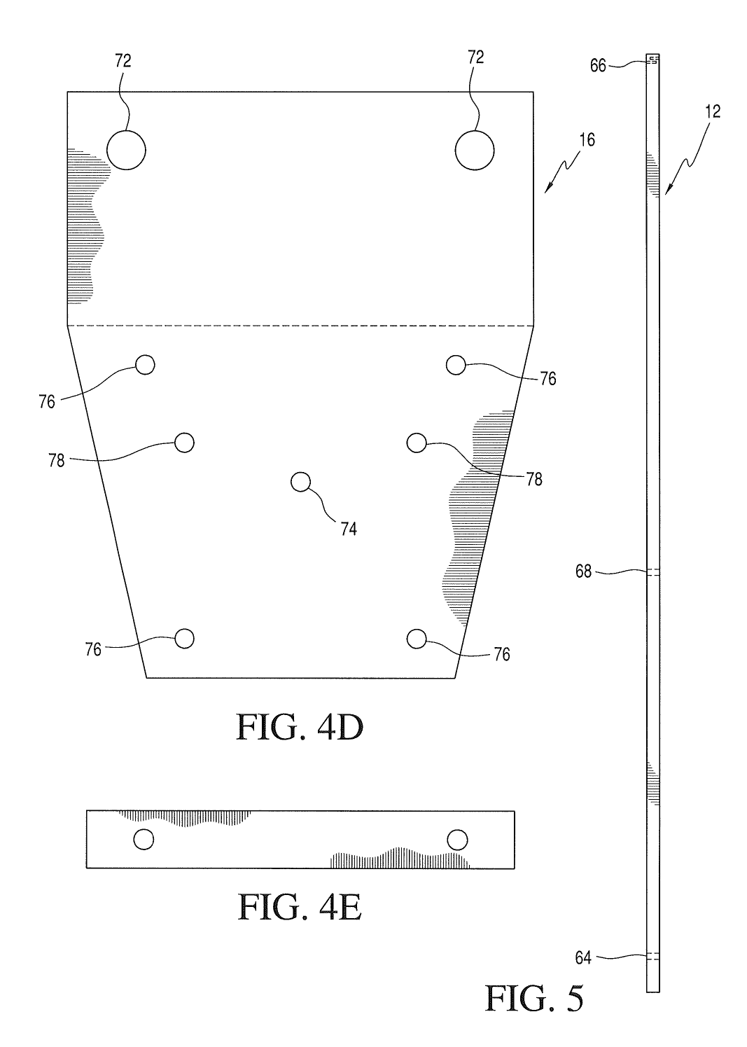

The eyelet 38 may be a conventional metal eyelet with a threaded neck portion that may be inserted into the hole 68 formed in the flag pole 12 and secured to the pole by nut connection or rivet connection or other desired fastener. See FIGS. 3 and 4A.

The mounting comprises a first base plate 16 and second base plate 18. The mounting should be formed of a material that will withstand weather conditions for outdoor use. The base plates 16, 18 in one embodiment comprise stamped steel plates with pre-formed holes at various locations. The stamped steel plates may have a thickness of about ⅛ inch. The flat stamped steel plates are then bent at 90 degrees to form L-shaped brackets or base plates 16, 18. Compare FIGS. 4D and 4E with FIGS. 1 and 4A. Holes 72 in one portion of the base plates are adapted to receive stakes 20 for securing the base plates to a mounting surface, such as the ground. Holes 74 are adapted to receive pivot pin or shaft 22 that extends through the pole 12 to join the pole 12 to the base plates 16, 18 for pivoting or rotating movement about the pivot pin or shaft 22. Holes 76 are adapted to receive rivots or other fastening means to join base plate 16 to base plate 18 to create the mounting. Holes 78 are adapted to receive pivot pin or shaft 30 to join the the bottom end of the upright 24 to the mounting.

Alternatively, the mounting may be formed of a single construction, rather than as two separate base plates joined or fastened together.

The upright 24 may comprise a metal bar that is bent at its upper end 28 to form an inverted U-shape. Holes 36 are formed through the upper end of the upright or bar 24. A shaft or pivot point 32 is positioned through such holes 36 and receives a pulley wheel 34. Holes 35 are formed in the lower end of the upright or bar 24, and holes 37 are formed along the length of the upright or bar 24. Holes 35, 37 are adapted for receiving fasteners to join the upright 24 to the first base plate 16 and second base plate 18. See FIGS. 4A, 4B and 4C. As shown in FIG. 1, the upright 24 may be held between the upwardly directed walls of the base plates 16, 18 of the mounting. Alternatively, as shown in FIG. 4A, the upright 24 may be joined to an outwardly facing surface of the upwardly directly wall of one of the base plates.

As shown in FIG. 4A, the resilient or elastic cord 40 may be joined at one end to the eyelet 38 of the pole 12, such as by a knot or by connection to a carabiner 42 or other hook or fastening means. In this embodiment, the resilient or elastic cord 40 comprises a “Bungee” cord. The resilient or elastic cord 40 is secured to a mounting surface, such as the ground, at its opposite end. As shown in FIG. 1, the resilient or elastic cord 40 is attached to a stake 46 that is inserted into the ground to hold that end of the cord 40 to the ground. The resilient or elastic cord 40 biases the flag pole 12 to a grounded or down position.

Referring to FIGS. 1 and 4A, a pull cord 60 is joined at one end to the eyelet 38 of the pole 12. The cord 60 contacts the pulley wheel 34 of the upright 24. The bent upper end 28 of the upright 24 retains the pull cord 60 within the upright, keeping it from jumping off the pulley assembly when the cord is slack. When a hunter tugs on the pull cord 60, the pulling force overcomes the biasing force of the resilient or elastic cord 40 so that the flag pole 12 is drawn upwards by pivoting upon pivot pin 22 associated with the mounting 16, 18. The flag 14 is then displayed in a position above the ground. The wing portions of the flag 14 may be caused to flutter or twitch to replicate landing motions or feeding motions of a duck or goose by releasing and re-pulling the pull cord 60. When the pull cord 60 is released, the biasing force of the resilient or elastic cord 40 draws the flag 12 to the ground.

The pull cord 60 preferably is a rope or tie down generally braided of natural or synthetic fibers, such as cotton, nylon, polyester, and/or polypropylene. The pull cord 60 may comprise a single length of rope or tie down or a combination of sections of rope or tie down that extend to about 6 feet or to any desired length longer than about 6 feet. The length of the pull cord 60 determines how far from the decoy system 10 the hunter may be positioned while still activating the decoy system to move the flag pole 12 and induce flutter motions in the flag 12.

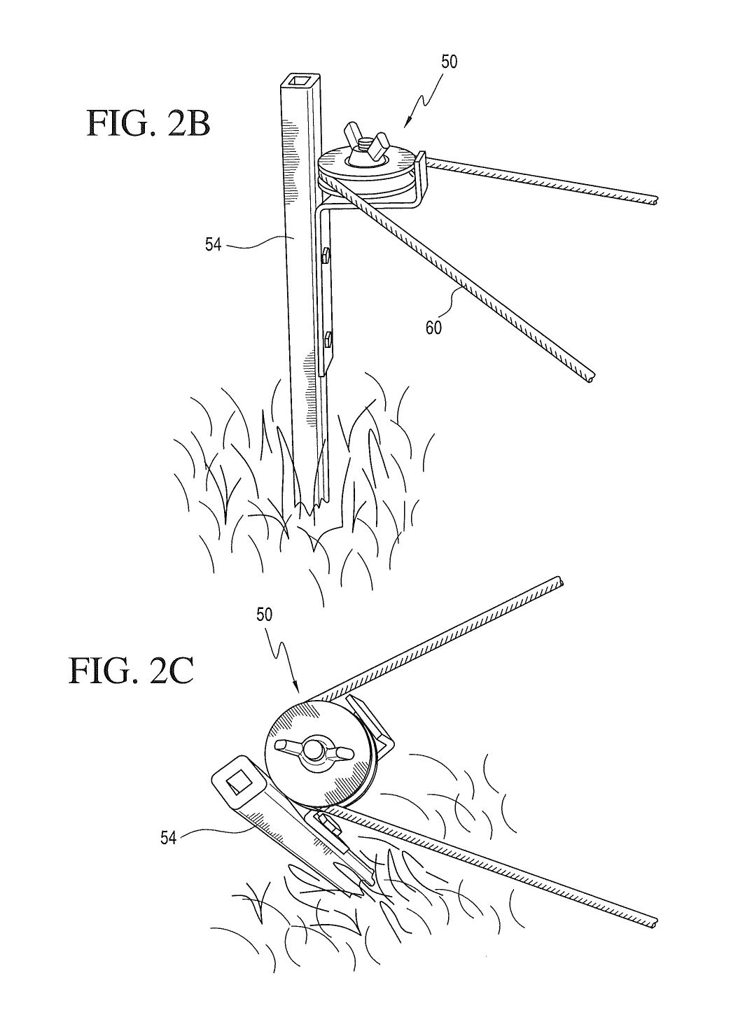

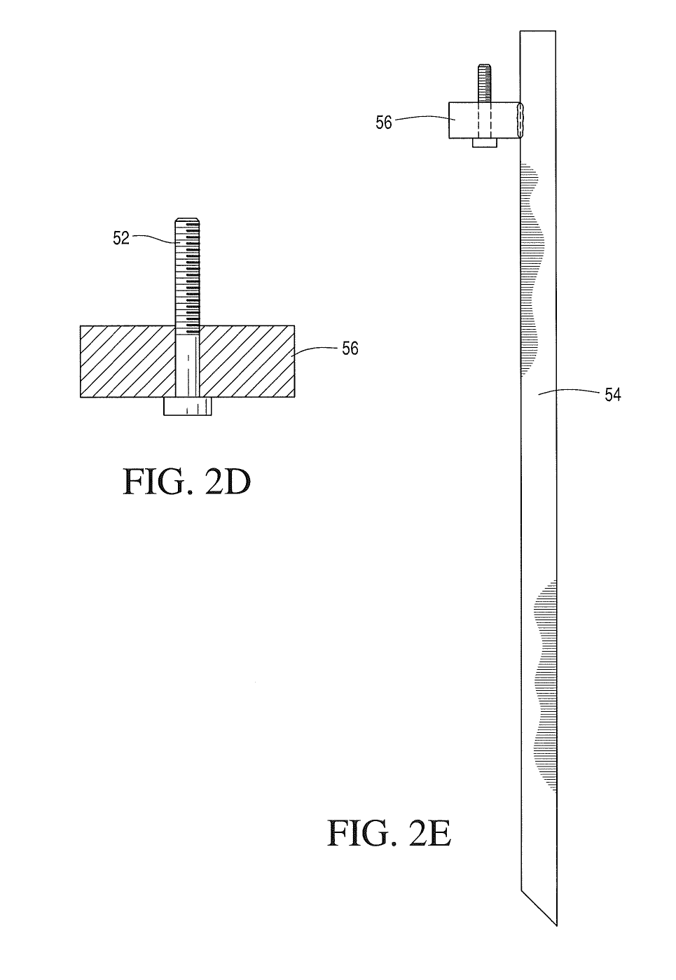

Referring to FIGS. 2A, 2B, 2C, 2D and 2E, the decoy system 10 may include an optional redirection mechanism with a redirection pulley 50 that is mounted to a stake 54 disposed at a distance from the bracket plates 16, 18 of the mounting. The redirection pulley 50 comprises a pulley wheel mounted for rotation to a shaft 52 associated with the stake 54. In one embodiment, the shaft 52 is mounted on a cantilever bracket assembly 56 or stand off attached or formed at or near the upper end of the stake 54. The pull cord 60 may be threaded onto the pulley wheel of the redirection pulley 50 so that the pull cord may be pulled from a direction at an angle to the pulley 34 provided on the upright 24. The pulley 34 may be positioned close to the side edge of the stake 54 so that the edge of the pulley closest to the stake 54 leaves a gap that is too small for the pull cord 60 to come off of the pulley 34. The stake 54 may have a length of about 12 to 20 inches, preferably about 16 inches, and be formed of 16 gauge steel square tube. The cantilever bracket assembly 56 may be tack welded to one side of the stake 54. The shaft 52 may comprise a bolt threaded through a hole formed through the cantilever bracket.

The pull cord 60 may be of a longer length when the optional redirection pulley 50 is included as a part of the decoy system 10. The pull cord 60 may have a length in the range of about 6 feet to about 200 feet.

The pulley 34 associated with the upright 32 has the advantage of smoothly traversing the pull cord 60 through the desired back and forth motion while protecting such cord from wearing or fraying. The pulley 50 of the redirection mechanism similarly has the advantage of smoothly traversing the pull cord 60 through the desired back and forth motion while protecting such cord from wearing or fraying.

Thus, various configurations of water fowl decoy motion systems are disclosed. While embodiments of this invention have been shown and described, it will be apparent to those skilled in the art that many more modifications are possible without departing from the inventive concepts herein. Moreover, the examples described herein are not to be construed as limiting. The invention, therefore, is not to be restricted except in the spirit of the following claims.

What is claimed is:

1. A decoy system, comprising:
a mounting securable to a ground surface;
a pole with a top end and a bottom end, said pole pivotably attached at or near its bottom end to the mounting;
a decoy flag attached or joined at or near the top end of the pole;
a resilient cord attached or joined at or near one end to the pole and securable at or near its other end to a ground surface;
an upright associated with the mounting and defining a pull cord pathway; and
a pull cord secured at one end to the pole and traversing the pull cord pathway.

2. The decoy system of claim 1, wherein the pull cord pathway is a pulley.

3. The decoy system of claim 1, wherein the decoy flag has a waterfowl configuration.

4. The decoy system of claim 3, wherein the decoy flag is a duck flag or a goose flag.

5. The decoy system of claim 1, further comprising a pull cord redirection mechanism.

6. The decoy system of claim 5, wherein the pull cord redirection mechanism comprises a pulley wheel mounted to a stake, with said stake securable to or into a ground surface.

7. The decoy system of claim 1, further comprising an eyelet associated with the pole to which the pull cord is attached.

8. The decoy system of claim 7, wherein the resilient cord is attached to the eyelet.

9. The decoy system of claim 1, wherein the resilient cord comprises a bungee cord or an elastic band.

10. The decoy system of claim 8, wherein the resilient cord is attached to a carabiner, and said carabiner is attached to the eyelet.

11. The decoy system of claim 1, wherein said upright is fastened to the mounting.

12. The decoy system of claim 1, further comprising one or more stakes adapted for securing the mounting to a ground surface.

13. A method for attracting waterfowl, comprising pulling the pull cord of the decoy system of claim 1 along the pull cord pathway to raise the pole up from a grounded position.

14. The method of claim 13, further comprising releasing the pull cord of the decoy system after said pulling to return the pole to its grounded position.

15. A method for attracting waterfowl, comprising a combination of pulling the pull cord of the decoy system of claim 1 along the pull cord pathway and releasing the pull cord of the decoy while the pole remains up from a grounded position.

16. The method of claim 15, wherein the combination of pulling the pull cord and releasing the pull cord generates a flapping or fluttering wing motion by the decoy flag.
